(19) United States
(12) Patent Application Publication
(10) Pub. No.: US 2014/0110648 A1
(43) Pub. Date: Apr. 24, 2014

(54) SUPPORT AND INSTALLATION CONNECTOR AND METHOD FOR CABLES

(71) Applicant: Aetna Insulated Wire LLC, Virginia Beach, VA (US)

(72) Inventors: Richard WILLIAMSON, Chesapeake, VA (US); Howard Jackson, Virginia Beach, VA (US)

(73) Assignee: Aetna Insulated Wire LLC, Virginia Beach, VA (US)

(21) Appl. No.: 14/035,158

(22) Filed: Sep. 24, 2013

Related U.S. Application Data
(60) Provisional application No. 61/704,996, filed on Sep. 24, 2012.

(51) Int. Cl. H02G 1/08

(52) U.S. Cl. CPC H02G 1/083
USPC 254/134.3 R

(57) ABSTRACT

A connector for lifting and supporting a cable having at least one tensile member includes a body adapted to be engaged by both a lifting mechanism and a support structure. A number of battens are attached to the body. A king in is positioned through the battens and is adapted to support the at least one tensile member between the battens.

### CLAIM OF PRIORITY

This application claims priority to U.S. Provisional Patent Application No. 61/704996, tiled Sep. 24, 2012, the contents of which are hereby incorporated by reference:.

### FIELD OF THE INVENTION

The present invention relates generally to electrical cables and, in particular, to a connector and method for installing and supporting cables in generally vertical passageways.

### BACKGROUND

Cables specifically designed for vertical applications typically feature tensile members that are used to lift the cable through a generally vertical passageway. An example of such a cable is presented in FIG. 1, where the tensile members 20 are enclosed within the cable outer jacket 22 along with conductors 24. Conductors 24 may be replaced with members suitable for non-power applications, such as data and communication,

Historically, cables such as the one illustrated in FIG. 1 are raised through generally vertical passageways, such as bore-holes formed in mining operations, using “loops” formed from the tensile members of the cable and cable clamps (Crosby clamps). Such loops are passed over a clevis or hook and then the cable end is raised to the anchor location or point at the top of the generally vertical passageway using rope, cable or line that is connected to the clevis or hook.

When the cable, reaches the top of the generally vertical passageway, one tensile member is removed from the lifting hook and moved to the anchor point The process is repeated with each tensile member until all the cables are oil the hook/clevis and secured to the anchor location. This technique is applied under a number of different installation conditions including, but not limited to, the following:

1. With cables that have been clamped to the side of a shaft and arc therefore more or less already supported such that the top anchor serves simply as an additional safety factor.

2. After the cable has had temporary wooden clamps applied to support the weight of the cable during transfer.

3. Where the hooked tensile members are the only source of support for the weight of the cable.

There are two other methods of supporting a vertically installed cable. They are specific to the cable construction:

1. Steel wire armor applied to the outside of the cable has its own method of support and anchoring.

2. Cable supported using one or more messengers (tensile members) clamped to the outside of the cable along its length.

The method of transitioning the tensile members from the support rigging to the anchoring point suffers from the disadvantage that during the transition of tensile members, there are only two of the three (for example) tensile members supporting the cable. The third tensile member is unhooked and at this point does not support any of the load until it is re-established on the support structure.

In addition, transferring one tensile member at a time makes it very difficult to properly tension the tensile members so that when the installation is complete, the three tensile members share the load equally. The inequality in the tensions will either remain as such so that one member supports more load then the others, or in part the inequality will be compensated for by physical adjustments in the cable, such as the core unwrapping slightly around one of the tensile members and shifting of the tensile members so as to potentially damage the cable core.

Furthermore, there is a considerable amount of time spent doing the installation While the cable is “under tension.” The transfer takes up time and costly resources under critical conditions—when the cable is suspended—instead of doing “prep” work on the ground, when there is little risk and minimal resources in play.

Also, while the anchor design is the responsibility of the installation authority, cables supplied with “loops” are not designed by the installation authority and therefore open the possibility for installations that do not maintain the appropriate safety factor.

Finally, in the event that the cable needs to be removed, the prior art installation process needs to be repeated in reverse. This multiplies the disadvantages of the prior art process.

### BRIEF DESCRIPTION OF THE DRAWINGS

FIG. 1 is a cutaway, perspective view of a cable designed for installation in generally vertical passageways and an example of a cable suitable for use with the present invention;

FIG. 2 is a front elevational view of an embodiment of the connector of the invention;

FIG. 3 is a perspective view of the connector of FIG. 2 with the king pin removed;

FIG. 4 is a front elevational view of the connector of FIGS. 2 and 3 with tensile members and the king pin installed;

FIG. 5 is a perspective view of the connector with tensile members of FIG. 4 lifted into position with respect to an anchor support structure at the top of a generally vertical passageway;

FIGS. 6A-6C are perspective, side elevational and front elevational views, respectively, of the connector and tensile members of FIGS. 4 and 5 installed in the anchor support structure of FIG. 5.

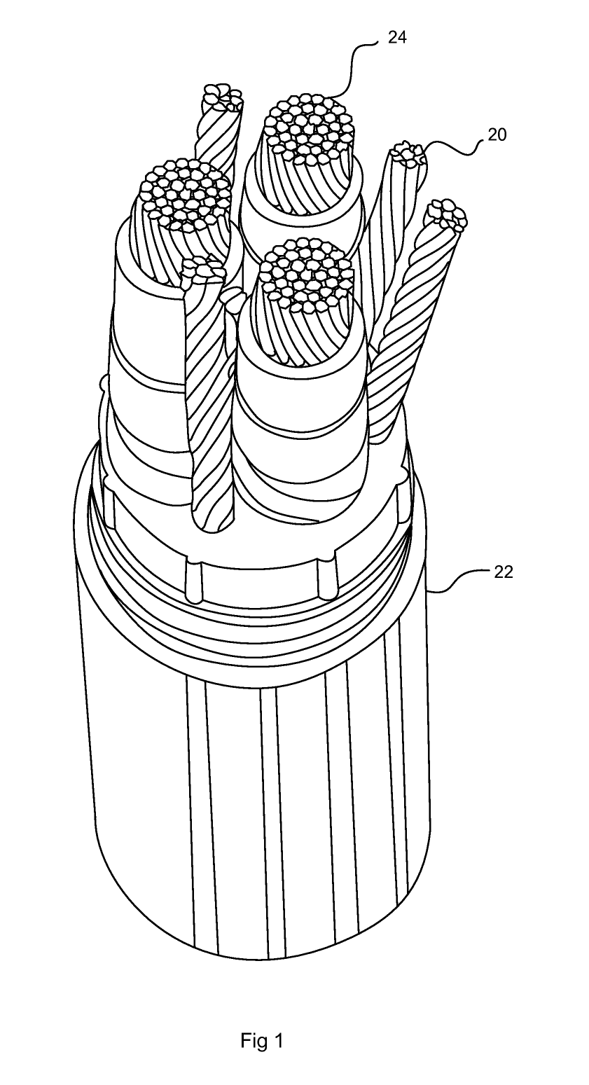

### DETAILED DESCRIPTION OF EMBODIMENTS

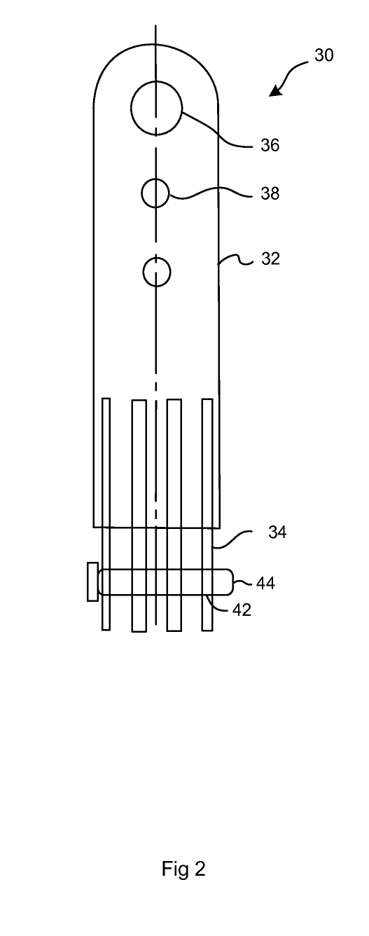

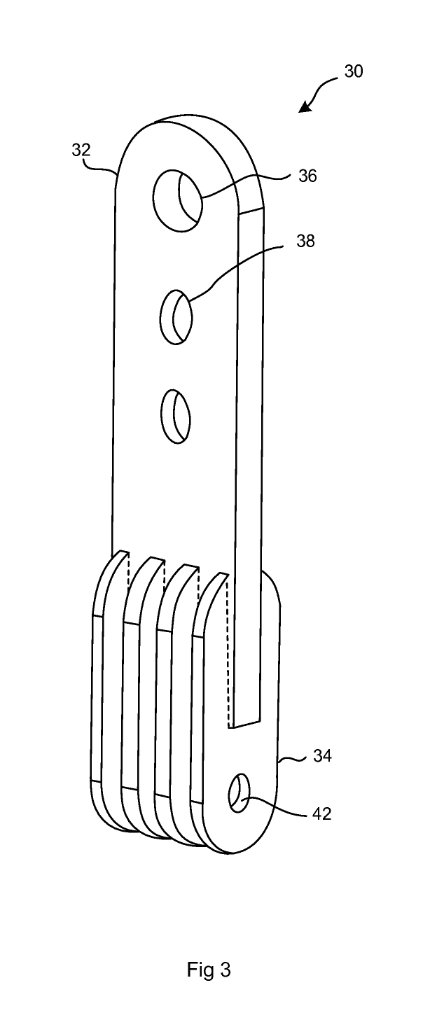

An embodiment of the connector of the invention, is indicated in general at 30 in FIGS. 2 and 3. The connector includes a body 32 and a number of battens 34. While four battens are shown, an. alternative number may be used. The body 32 includes a lifting opening 36 and attachment openings 38. The body and battens are preferably constructed from steel, but any durable material may be used. While the body is illustrated as a plate and the battens are illustrated as plates positioned generally perpendicular to the body plate, other configurations may be used for the connector body and battens.

The battens are each provided with, a pin opening 42. The pin openings are aligned and sized to receive a king pin 44. One end of the king pin includes an enlarged head portion. The opposite end of the king pin may be enlarged to secure the king pin within the openings 42, or fasteners known in the art including, but not limited to, a pin, cap or nut may be used to secure the king pin through the battens. Alternatively, the king pin or other members may be integrally formed between the battens.

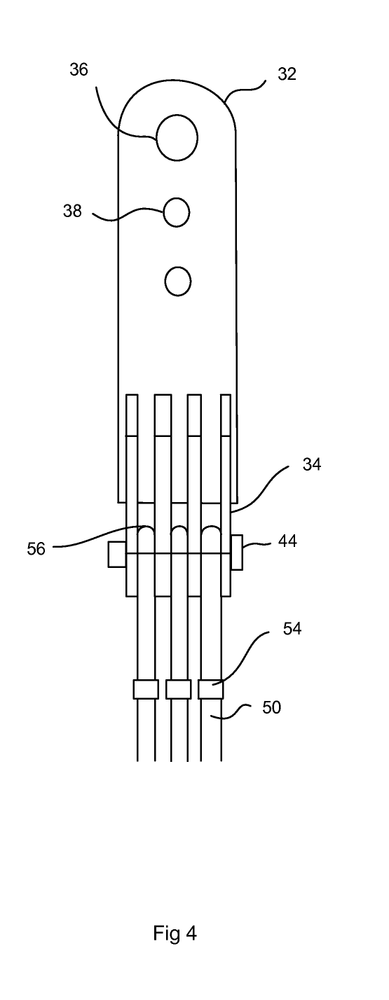

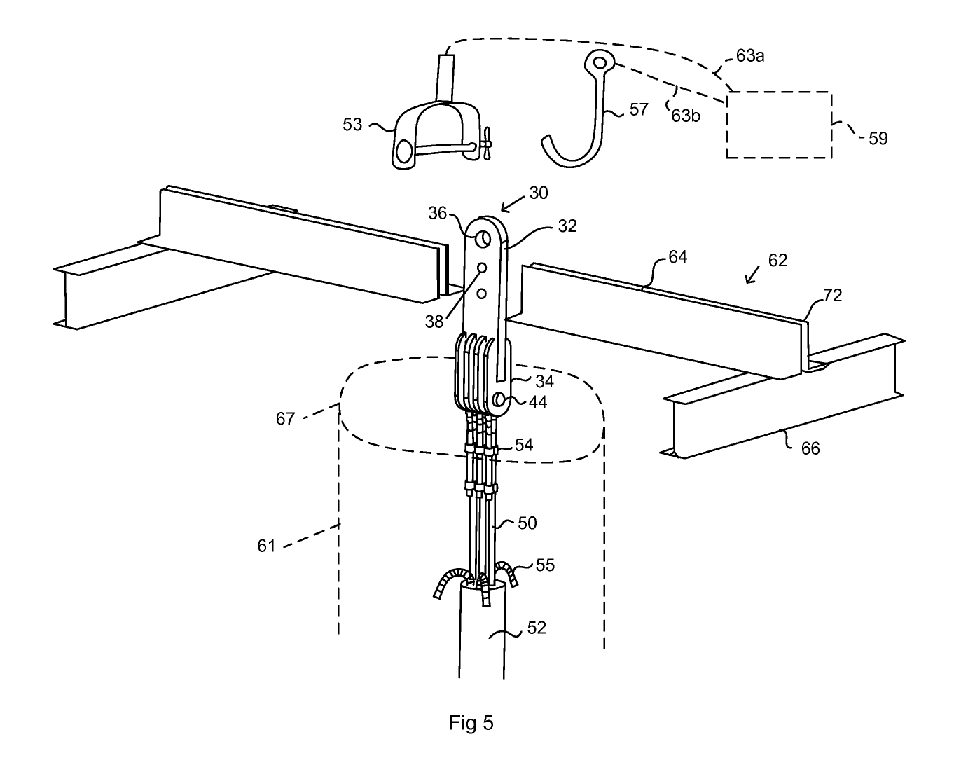

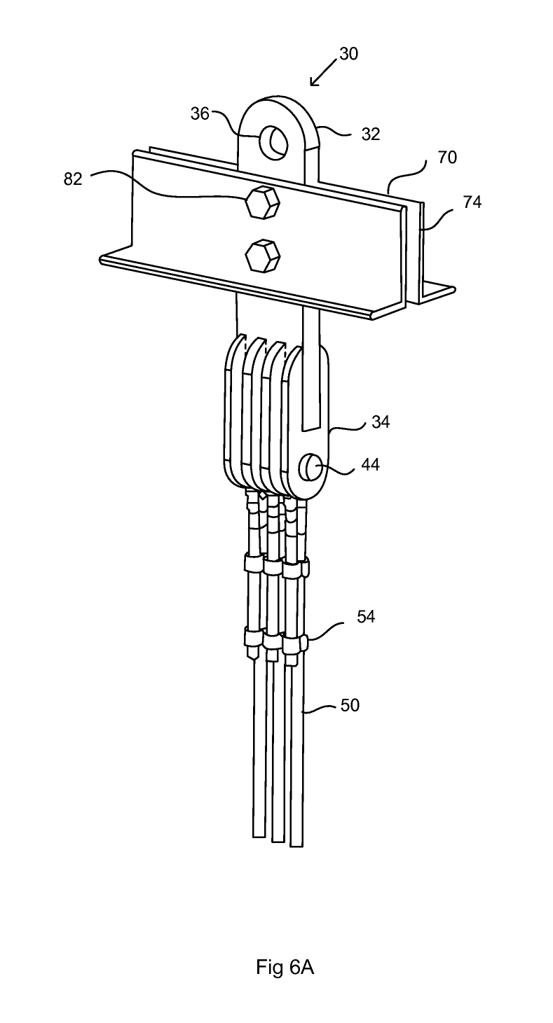

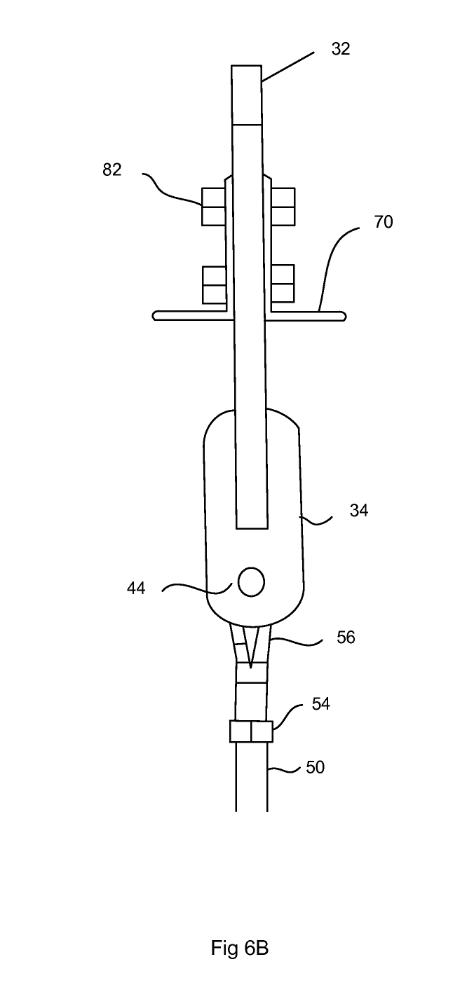

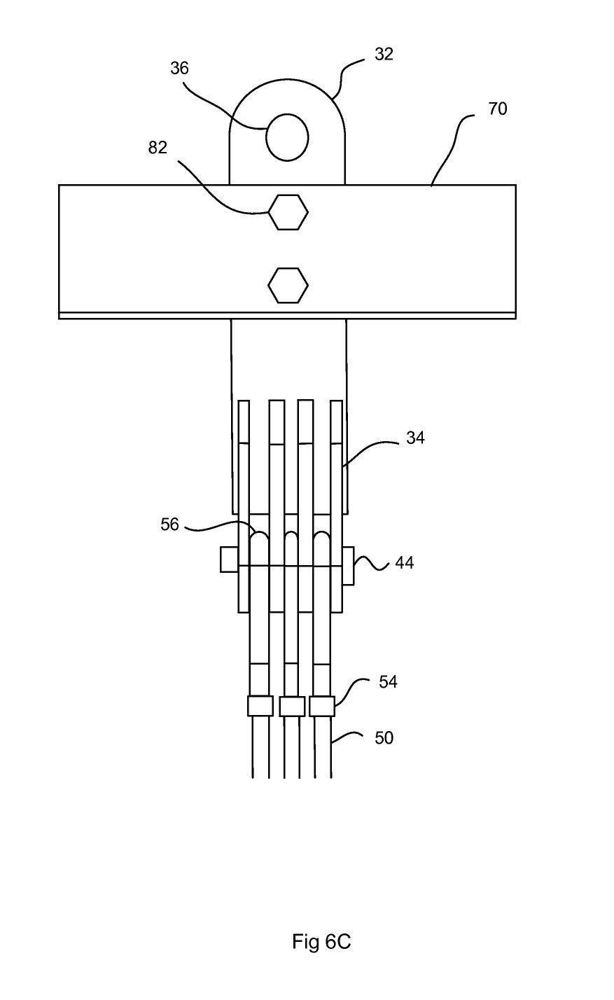

In order to use the connector 30, and in accordance with an embodiment of the method of the present invention, individual tensile members, indicated at 50 in FIGS. 4 and 5, of a cable 52 are looped on themselves and secured using appropriate cable clamps/U-clamps (such as, for example, Crosby clamps) 54 so that tensile member loop portions 56 (best shown in FIGS. 4, 6B and 6C) are formed. The conductors or other functional members of the cable 52 are indicated at 55 in FIG. 5. The cable loops 56 are made over the king pin 44 at the bottom of the connector, each cable fitting, between two of the battens 34 that extend from the body 32 of the clamping mechanism. Alternatively, the king pin 44 may be removable so that the tensile member loops may be pre-formed and, prior to installation of the king pin 44 through the battens 34, positioned between the battens and then the king pin inserted through the openings 42 (FIGS. 3 and 4) and the loops 56. The connector can be factory installed or installed to the tensile members at the site.

The connector can be custom designed. to address the weight of each cable installed and the end users requirement for an applied safety factor. Typically the cables are in the seventeen to eighteen thousand pound range and arc subject to a safety factor in the order of 5. As an example only, the connecter may be designed to support 100,000 lbs. Different standard sizes of the connector may be made for ranges of cable Weights and tensile member sizes.

In accordance with an embodiment of a method of the invention, the connection of the cable 52 to the connector 30 is done on the ground and is never disconnected. Once the tensile members 50 are in place between the battens of the connector (as illustrated in FIG. 4), a lifting clevis (53 in FIG. 5) or a lifting hook (57 in FIG. 5) of a lift mechanism is attached to the lifting opening 36 of the body. Suitable lifting mechanisms, represented schematically by block 59 in FIG. 5, are known in the art and include, but are not limited to, hoists, wenches, pulley arrangements or the like that are powered by electric motors, motors powered by gasoline or other fuels or that include cranks and mechanisms so that the lifting mechanism may be powered manually.

The connector and the cable, as illustrated in FIG. 5, is then raised through a generally vertical passageway (such as a mining bore-hole, for example), indicated in phantom at 61, and into place with respect to the anchor support structure, indicated in general at 62. The generally vertical passage 61 may be any passage formed through the ground or a structure. The lifting hook or clevis of the lifting mechanism may be attached to the lifting mechanism by way of a retractable lifting cable, rope or any other type of line known in the art, as illustrated schematically at 63a and 63b in FIG. 5.

As illustrated in FIG. 5, the anchor support structure 62 includes a main support beam 64 and a pair of end beams 66 made of steel or another durable material. The main support beam 64 may, for example, traverse the top opening 67 (FIG. 5) of the generally vertical passage with the end beams 66 placed on the ground surrounding the opening 67. The central portion of the main support beam 64 has been omitted from FIG. 5 for clarity and is indicated at 70 in FIGS. 6A-6C. Of course any alternative support structure adapted to attach to the connector may be used for the anchor support structure 62.

As illustrated in FIGS. 5 and 6A-6C, when the top end of cable 52 reaches the top of the pull, the body 32 of the connector is moved into place against the central section 70 (FIGS. 6A-6C) of the main support beam 64 (FIG. 5) of the anchor support structure supplied by the end user. In the embodiment of FIGS. 5 and 6A-6C, the main support beam 64 and 70 of FIGS. 5 and 6A-6C takes the form of a pair of steel angles 72 (FIG. 5) and 74 (FIGS. 6A-6C). One of the angles 72 and 74 is positioned across end beams 66. When the connector is in place (the position of FIGS. 5 and 6A-6C), the other angle (i.e. the other half) of the main support beam is moved into place and two support pins or bolts 82 are inserted through openings in the central portions of the main support beam angles 74 and the attachment openings 38 (FIGS. 2-4) of the connector locking the connector in place. The lifting hook or clevis of the lift mechanism may then be released from the lift opening 36. Alternatively, the connector may be lifted between the angles 72 and 74 and secured in place.

The above embodiment of the connector of the invention and associated method offers the following advantages:

1. Eliminates the need for transferring the tensile members and the associated risk of doing this under load.

2. Reduces the installation time when there are high-cost resources involved (crane, additional personnel etc).

3. Reduces risk exposure time.

4. Allows the tensile members to be installed in such a way that each member more or less takes an equal share of the load.

5. Ensures the safety factor is maintained by supplying the proper anchor bolts for the top end connector.

6. Allows for easy removal.

While the preferred embodiments of the invention have been shown and described, it will be apparent to those skilled in the art that changes and modifications may be made therein without departing from the spirit of the invention, the scope of which is defined by the appended claims.

What is claimed is:

1. A connector for lifting and supporting a cable having at least one tensile member comprising;
a. a body adapted to be engaged by both a lifting mechanism and a support structure;
b. a plurality of battens attached to the body; and
c. a king pin positioned through the plurality of battens and adapted to support the at least one tensile member between the battens.

2. The connector of claim 1 wherein the body includes a lifting opening and an attachment opening adapted to engage the lifting mechanism and the support structure, respectively.

3. of The connector of claim l wherein the plurality of battens feature aligned pin openings and the king pin is removably received through pin openings of the plurality of battens.

4. The connector of claim I wherein the king pin is permanently secured between the plurality of battens.

5. The connector of claim I wherein the body is a plate and the plurality of battens are plates positioned generally perpendicular to the body plate and parallel to one another in a spaced configuration so that cable tensile members may be received there between.

6. The connector of claim 1 wherein the at least one tensile member of the cable includes a loop formed at an end thereof and the king pin of the connector is adapted to pass through the loop.

7. The connector of claim I wherein the connector body and battens are constructed from steel.

8. A method for lifting a cable having tensile members through a generally vertical passage and supporting the cable at the top of the passage comprising the steps of:
a. providing a connector having a body with a plurality of battens attached thereto with a kin pin passing through the battens;
b. attaching tensile members to the connector so that they pass between the battens and are supported by the king pin;
c. engaging the connector body with a lifting mechanism:,
d. raising the connector and cable through the generally vertical passage with the lifting mechanism;
e. attaching the body of the connector to an anchor support structure positioned at a top opening of the generally vertical passage; and
f. releasing the lifting mechanism from the connector.

9. The method for lifting of claim 8 wherein step b, includes thrilling the tensile members into a loop through which the king pin is received.

10. The method for lifting of claim 8 wherein the body of the connector includes a lifting opening and the lifting mechanism includes a hook or clevis that engages the lifting opening.

11. The method for lifting of claim 8 wherein step e, is accomplished using support pins or bolts that pass through corresponding openings in the support structure.

12. A system for lifting a cable having at least one tensile member through a generally vertical passage having a top opening and for supporting the lifted cable comprising;
a. a support structure adapted to traverse at least a portion of the top opening;
b. a connector including:
i) a body adapted to be engaged by both a lifting mechanism and the support structure;
ii) a plurality of battens attached to the body; and
iii) a king pin positioned through the plurality of battens and adapted to support the at least one tensile member between the battens.

13. The system of claim 12 wherein the body of the connector includes a lifting opening and an attachment opening adapted to engage the lifting mechanism and the support structure, respectively.

14. The system of claim 12 wherein the plurality of battens of the connector feature aligned pin openings and the king pin is removably received through pin openings of the plurality of battens.

15. The system of claim 12 wherein the king pin is permanently secured between the plurality of battens of the connector.

16. The system of claim 12 wherein the body of the connector is a plate and the plurality of battens are plates positioned generally perpendicular to the body plate and parallel to one another in a spaced configuration so that cable tensile members may be received there between.

17. The system of claim 12 wherein the at least one tensile member of the cable includes a loop formed at an end thereof and the king pin of the connector is adapted to pass through the loop.

18. The system of claim 12 wherein the connector body and the plurality of battens are constructed from steel.

19. The system of claim 12 wherein the support structure includes a main support beam formed from a pair of angles, said main support beam mounted upon a pair of end beams adapted to be positioned on generally opposite sides of the top opening, said pair of angles spaced to receive the body of the connector there between, and a connector for securing the body to the main support beam.

20. The system of claim 12 further comprising a lifting mechanism adapted to engage the body of the connector and to lift the cable through the generally vertical passage.
